(19) United States
(12) Patent Application Publication
(10) Pub. No.: US 2022/0217542 A1
(43) Pub. Date: Jul. 7, 2022

(54) DETERMINING AVAILABLE CAPACITY PER CELL PARTITION

(71) Applicant: TELEFONAKTIEBOLAGET LM ERICSSON (PUBL), Stockholm (SE)

(72) Inventors: Angelo CENTONZA, Torrenueva Costa (ES); Pablo SOLDATI, SOLNA (SE)

(21) Appl. No.: 17/603,824

(22) PCT Filed: Apr. 27, 2020
(86) PCT No.: PCT/IB2020/053933

§ 371 Date: Oct. 14, 2021

Related U.S. Application Data
(60) Provisional application No. 62/841,870, filed on May 2, 2019.

(51) Int. Cl. H04W 16/10

(52) U.S. Cl. CPC H04W 16/10

(57) ABSTRACT

According to some embodiments, a method performed by a network node for determining available capacity comprises determining an available capacity of one or more partitions of a radio cell and transmitting a resource status information message to another network node. The resource status information message comprises at least one of the determined available capacities of the one or more partitions of the radio cell.

### TECHNICAL FIELD

Particular embodiments relate to wireless communication, and more specifically to determining available capacity per cell partition.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

In Third Generation Partnership Project (3GPP) fifth generation (5G) new radio (NR) wireless networks, a radio cell may transmit multiple synchronization signals (SS) and physical broadcast channel (PBCH) blocks (SSB) for cell search and synchronization, An SSB consists of a primary and secondary synchronization signals (PSS, SSS), each occupying 1 symbol and 127 subcarriers, and a PBCH signal spanning across 3 orthogonal frequency division multiplexing (OFDM) symbols and 240 subcarriers, with one symbol having an unused part in the middle for SSS.

The sub-carrier spacing determines the possible time locations of SSBs within a half-frame. The network configures the periodicity of the half-frames where SSBs are transmitted. During a half-frame, the network may transmit different SSBs in different spatial directions (e.g., using different spatial beams spanning the coverage area of a cell).

Multiple SSBs may be transmitted within the frequency span of a carrier. The physical cell identifiers (Pas) of SSBs transmitted in different frequency locations are not necessarily unique, but different SSBs in the frequency domain can have different PCIs. When an SSB is associated with a remaining minimum system information (RMSI), however, the SSB corresponds to an individual cell, which has a unique NR cell global identity (NCO). Such an SSB is referred to as a cell-defining SSB (CD-SSB). A PCell is always associated to one and only one CD-SSB located on the synchronization raster.

Because a network may transmit SSB beams to cover different parts of the cell's coverage area, and from a user equipment (UE) perspective measurement reports are based on detection of such SSBs, it is possible to divide the cell in SSB coverage areas and to determine parameters such as load, composite capacity, and resource status information for each partition of the cell. With this approach, SSB measurement reports from a UE enable the network to assess which portion of the cell the UE is located and the resource status information for that partition of the NR cell. This provides a significantly finer granularity than in long term evolution (LTE) where resource status information is available at a per cell level. An example is illustrated in FIG. 1.

FIG. 1 is a block diagram illustrating resource utilization for multiple cells. As illustrated, gNB₁ controls a serving cell with a plurality of UEs, and gNB₂ controls two cells, Cell-A and Cell-B, Each of the ovals represents a particular beam. The illustrated load distribution is unbalanced between SSB within an NR cell and can benefit from mobility load balancing (MLB) to the coverage area of SSB with low load.

Using resource status information per SSB beam can be beneficial for enhancing MLB in NR. The illustrated NR serving cell (gNB₁) is highly loaded at least in some local area defined, for instance, by the coverage area of different SSB beams. A target UE in the loaded area may report measurements that a neighbor Cell-A is detected with good radio conditions, possibly including beam measurements, and also reports another cell that is farther away e.g. Cell-B.

Using the LTE MLB solution as a baseline for NR, the serving node can request resource status information from the target node. The resource status information may indicate a high load in Cell-A. A high load may be at least the same number of UEs and same traffic as the serving node is experiencing. If only cell-specific resource status information is available, the loaded serving node may be led to believe that the target node is also overloaded. With SSB-beam specific resource status information available, however, the serving cell can determine that, in the beam coverage area where the UE is moving. Cell-A has enough available capacity to accept the UE.

LTE defines the cell composite available capacity to indicate the overall available resource level in a cell in either downlink or uplink. The composite available capacity (CAC) is defined as (see IS 32.522): Composite Available Capacity=Cell Capacity Class Value*Capacity Value. The Cell Capacity Class Value (CCCV) indicates the value that classifies the cell capacity with regards to the other cells. The Cell Capacity Class Value information element (IE) only indicates resources that are configured for traffic purposes and it is expressed with an integer ranging from 1, indicating the minimum cell capacity, to 100 indicating the maximum cell capacity, following a linear relation between cell capacity and the Cell Capacity Class Value as described in TS 36.331.

In TS 36.423, the cell capacity class value is an optional parameter in case of intra-LTE load balancing. If cell capacity class value is not present, then IS 36.423 assumes that bandwidth should be used instead to assess the capacity. The Capacity Value (CV) indicates the amount of resources that are available relative to the total evolved universal terrestrial radio access network (E-UTRAN) resources. The capacity value should be measured and reported so that the minimum E-UTRAN resource usage of existing services is resented according to implementation. The Capacity Value IE ranges between 0, indicating no available capacity, and 100 which indicates maximum available capacity. Capacity Value should be measured on a linear scale.

There currently exist certain challenges. For example, a cell-specific CAC as defined in LIE has at least two shortcomings. For multiple input multiple output (MIMO) transmission capability, a cell-specific CAC may incorrectly represent the cell available capacity. Furthermore, a cell specific CAC value does not provide any information about the distribution of the cell load or available capacity in the spatial domain. The latter aspect is important to optimize the network operation in case of advance antenna systems capable of MIMO transmission with narrow beams, like in the 3GPP NR system or LIE system with massive NEMO antenna array. An example is illustrated in FIGS. 2A and 2B.

FIGS. 2A and 2B illustrates cell resource availability for a cell with MIMO capabilities. The illustrated example includes LTE cell-specific CAC used for characterizing the available capacity in a radio cell capable of spatial multiplexing users via MIMO transmission and assumes CCCV=100 and 4 SSSB beams. FIG. 2A illustrates how resources are used to serve UEs under the coverage area of each of the SSB beams. FIG. 2B illustrates how resources are utilized from the cell perspective:

FIG. 2A illustrates light traffic scheduled under the coverage area of all SSB beams. In particular, the cell schedules: (a) users within the coverage area of SSB1 only in 40% of the resources; (h) users within the coverage area of SSB2 only in 20% of the resources; (c) users within the coverage area of SSB3 only in 20% of the resources; and (d) users within the coverage area of SSB4 only in 40% of the resources.

With MIMO transmission capabilities, the available capacity under the coverage area of each SSB beam may range between 60% and 80%. Therefore, the cell overall appears lightly loaded and could accept more users/traffic under the coverage area of all SSB beams.

Using a cell-specific CAC as defined in the LTE system, however, only 30% of the capacity appears available (i.e., CAC=3000 out of a CAC_max=10000). In other words, the cell is considered highly loaded. A similar conclusion can be drawn if defining the available capacity for a traffic slice.

### SUMMARY

As described above, certain challenges currently exist with determining composite available capacity (CAC) for a cell. Certain aspects of the present disclosure and their embodiments may provide solutions to these or other challenges.

For example, particular embodiments determine the available capacity in different regions of the coverage area of a radio cell, as well as the overall cell capacity as a function of the capacity available in different regions of the cell's coverage area.

A particular embodiment includes a method executed by a first network node. The method comprises: computing the available capacity associated to one or more partitions of a radio cell; computing the available capacity associate to the radio cell based on the available capacity associated to one or more partitions of the radio cell; and transmitting a resource status information message to a second network node comprising the available capacity associated with one or more partitions of the radio cell and/or the available capacity associated to the radio cell.

In particular embodiments, a partition of a radio cell is represented by any one of the following: (a) the coverage area of reference signal beams, e.g. SSB beams; (h) a network slice; and/or (c) a network slice and the coverage area of a reference signal beam.

In some embodiments, a method executed by a first network node comprises: computing the available capacity associated to the coverage area of one or more reference signal spatial beams transmitted within a radio cell; computing the available capacity associated to the radio cell based on the available capacity associated to the coverage area of reference signal spatial beams transmitted in the radio cell; and transmitting a resource status information message to a second network node comprising the available capacity associated to the coverage area of one or more spatial beams transmitted within a radio cell and/or the available capacity associated to the radio cell, According to some embodiments, a method performed by a network node for determining available capacity comprises determining an available capacity of one or more partitions of a radio cell and transmitting a resource status information message to another network node. The resource status information message comprises at least one of the determined available capacities of the one or more partitions of the radio cell.

In particular embodiments, the method further comprises determining an available cell capacity for the radio cell based on the determined available capacity of the one or more partitions of the radio cell. The resource status information includes the available cell capacity for the radio cell.

In particular embodiments, determining the available capacity of one or more partitions of the radio cell is based on all cell resources being available to each of the one or more partitions of the radio cell.

For example, the available capacity of a partition of the radio cell may be a composite available capacity comprising a partition capacity class value and a partition capacity value wherein the partition capacity class value is equal to a cell capacity class value, and the partition capacity value is an amount of resources available within the partition relative to the partition capacity class value.

In particular embodiments, determining the available capacity of one or more partitions of the radio cell is based on a fraction of cell resources being available to each of the one or more partitions of the radio cell.

For example, the available capacity of a partition of the radio cell may be a composite available capacity comprising a partition capacity class value and a partition capacity value wherein the partition capacity class value is smaller than a cell capacity class value and the sum of the partition capacity class value of all partitions equals the cell capacity class value, and the partition capacity value is the amount of resources available within the partition relative to the partition capacity class value.

As another example, the available capacity of a partition of the radio cell may be a composite available capacity comprising a partition capacity class value and a partition capacity value wherein the partition capacity class value is smaller than a cell capacity class value and the sum of the partition capacity class value of all partitions exceeds the cell capacity class value, and the partition capacity value is the amount of resources available within the partition relative to the partition capacity class value.

In particular embodiments, determining the available cell capacity for the radio cell comprises averaging each of the available capacities of the one or more partitions of the radio cell.

In particular embodiments, the one or more partitions of the radio cell comprise coverage areas of one or more reference signal beams. The one or more reference signal beams may comprise one or more synchronization signal blocks (SSBs) beams. The one or more partitions of the radio cell may comprise one or more network slices, or the one or more partitions of the radio cell comprise one or more network slices and coverage areas of one or more reference signal beams.

According to some embodiments, a network node comprises processing circuitry operable to perform any of the network node methods described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments facilitate determination of an estimate of the available capacity in different regions of the coverage area of a radio cell capable of MEMO transmission. This can enable more efficient mobility related decisions in the system and more efficient load balancing and load sharing among radio cells, thus resulting in an overall better spectral efficiency and system performance.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a block diagram illustrating resource utilization for multiple cells;

FIGS. 2A and 2B illustrates cell resource availability for a cell with MIMO capabilities;

FIG. 3 is a graph illustrating the available capacity associated to the coverage area of four SSB reference signals of a 3GPP NR system with the cell-specific available capacity as defined by the 3GPP LTE system and with the cell-specific available capacity, according to particular embodiments;

FIG. 4 is a block diagram illustrating an example wireless network; and

FIG. 5 is a flowchart illustrating an example method in a network node, according to certain embodiments.

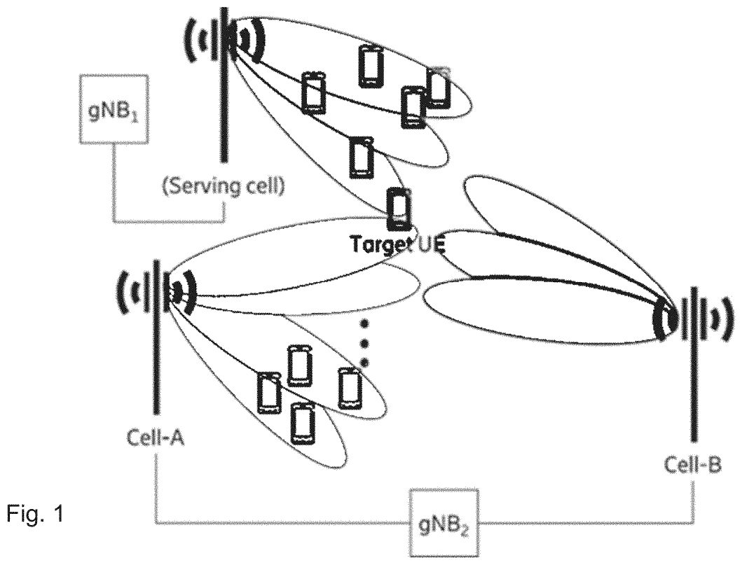

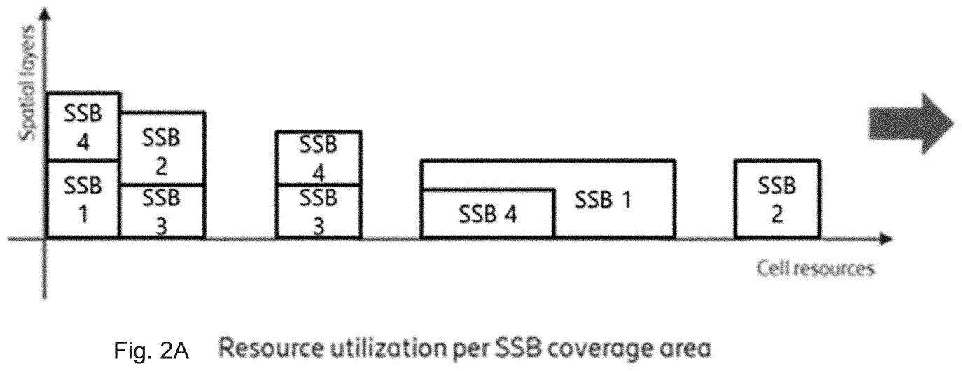

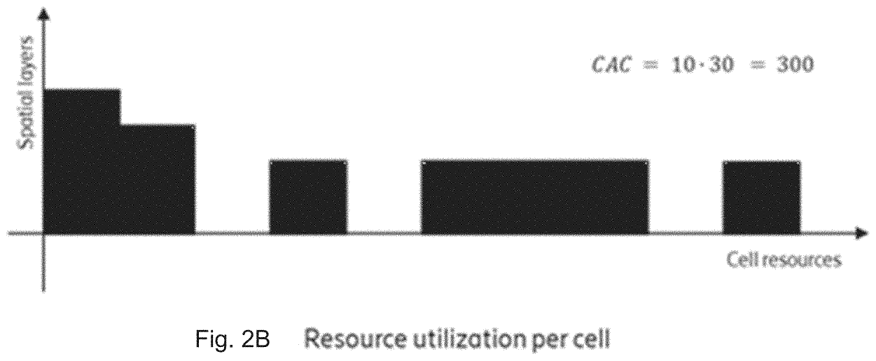

### DETAILED DESCRIPTION

As described above, certain challenges currently exist with determining composite available capacity (CAC) for a cell. Certain aspects of the present disclosure and their embodiments may provide solutions to these or other challenges.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Particular embodiments include capacity associated to coverage area of downlink reference signals beams. A partition of the radio cell may be represented by the coverage area associated to a downlink reference signal transmitted in a region of the cell's coverage area. In one example, the downlink reference signal is a synchronization signal (SS) and physical broadcast channel (PBCH) Blocks (SSB) transmitted in a predefined spatial direction using, for example, multiple-input multiple-output (MIMO) beamforming techniques. For ease of reference, this will be referred to as the coverage area of an SSB beam, or more generally the coverage area of a downlink reference signal beam.

In particular embodiments, the available capacity associated to the coverage area of a downlink reference signal beam is determined as Beam Composite Available Capacity=Beam Capacity Class Value*Beam Capacity Value. The Beam Capacity Class Value (BCCV) indicates the total resources configured within the cell for traffic purposes in the coverage area of a reference signal beam. The Beam Capacity Value (BCV) indicates the amount of resources that are available within the coverage area of the downlink reference signal beam relative to the total resources BCCV. The following short hand notation

CAC_{b}=BCCV_{b}·BCV_{b} b=1, . . . , N_{beams}

denotes the available capacity associated to the coverage area of N_{beams} downlink reference signals beams indexed by b=1, . . . , N_{beams}.

The value of BCCV_{b} can be determined as a function of the cell capacity class value (CCCV) depending on how the cell resources are distributed among different downlink reference signal beams. In one example, BCCV_{b}=CCCV for all reference signal beams in case of full reuse of the cell's resources among the coverage are of each reference signal beam. In another example, BCCV, can be fraction of CCCV such that Σ_{b=1}^{N}^{_{beams}}BCCV_{b}, =CCCV when the cell's resources are orthogonally divided among the coverage area of different reference signal beams.

In another example, when the cell's resources are partly reused among the coverage area of different SSB beams, BCCV_{b} can be a fraction of CCCV such that Σ_{b=1}^{N}^{_{beams}} BCCV_{b}≥CCCV. For example, the cell may allow full reuse among the coverage areas of each SSB, but in practice at the border between the coverage area of two SSBs it is possible that the scheduler will use different resources, thus BCCV_{b}≤CCCV but Σ_{b=1}^{N}^{_{beams}} BCCV_{b}≥CCCV.

In some embodiments, the available capacity associated to the radio cell is based on the available capacity associated to the coverage area of one or more reference signal beams. In one embodiment, the available capacity associated to the radio cell is computed as

$${CAC}_{cell} = \frac{CCCV}{{\sum }_{b = 1}^{{N}_{bems}} {BCCV}_{b}} {\sum }_{b = 1}^{{N}_{bems}} {CAC}_{b}$$

The sum of the available capacity CAC_{b} associated to the coverage area of multiple reference signal beams is scaled in proportion to the cell capacity class value normalized by the sum of the beam capacity class values. The normalization is useful in the case where the cell resources are reused, fully or only in part, between the coverage area of different reference signals.

In another embodiment, the available capacity associated to the radio cell is computed as

$${CAC}_{cell} = \frac{1}{{N}_{beams}} {\sum }_{b = 1}^{{N}_{beams}} {CAC}_{b}$$

The cell available capacity is represented by the average available capacity associated to the coverage area of multiple reference signal beams.

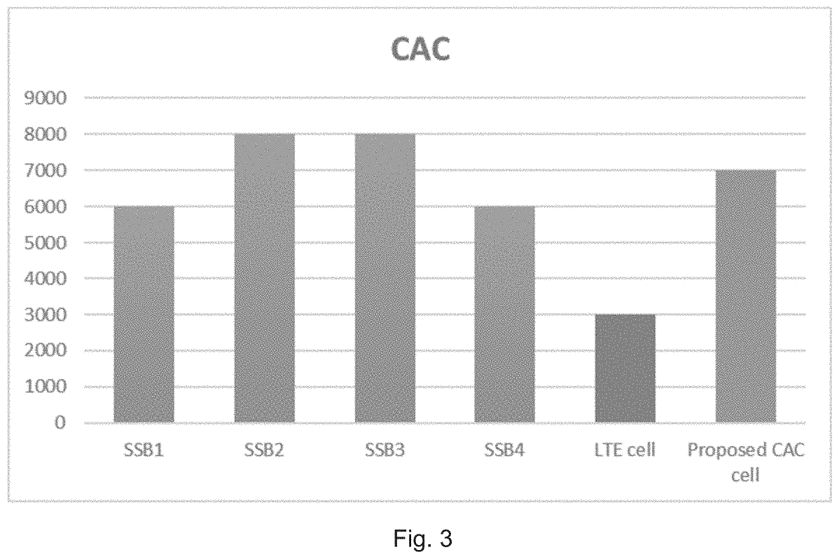

FIG. 3 is a graph illustrating the available capacity associated to the coverage area of four SSB reference signals of a 3GPP NR system with the cell-specific available capacity as defined by the 3GPP LTE system and with the cell-specific available capacity, according to particular embodiments. FIG. 3 illustrates how particular embodiments can be used to characterize the available capacity in different areas of a radio cell (e.g., the available capacity associated to the coverage area of different SSB beams) as well as to derive the cell-specific available cell capacity derived as a function of the available capacity in different areas of a radio cell. FIG. 3 also illustrates a comparison with the cell-specific available capacity that could be derived if it were an LTE cell. Based on the illustrated example, the state of the art cannot capture how radio resources are used/available over the spatial domain, nor can it correctly infer the cell available capacity when radio resources can be spatially reused with MIMO beamforming techniques.

Particular embodiments include capacity associated to network slices. A partition of the radio cell is represented as a network slice. The available capacity associated to a network slice can be determined as: Slice Composite Available Capacity=Slice Capacity Class Value*Slice Capacity Value. The Slice Capacity Class Value (SCCV) indicates the total resources configured within the cell for traffic purposes in the coverage area of a reference signal beam. The Slice Capacity Value (SCV) indicates the amount of resources that are available for the network slice relative to the total resources SCCV. The short hand notation

CACₛ=SCCVₛ·SCVsₛ=1, . . . , N_{slices}

denotes the available capacity associated to N_{slices} network slices indexed by s=1, . . . , N_{slices}.

The value of SCCVₛ can be determined as a function of the cell capacity class value (CCCV) depending on how the cell resources are distributed among different network slices. In one example, SCCVₛ=CCCV for all network slices if the cell resources can be fully reused by all network slices. In another example, SCCVₛ can be fraction of CCCV such that Σₛ₌₁^{N}^{_{slices}} SCCVₛ=CCCV in case the cell's resources are orthogonally divided among network slices.

In another example, when the cell's resources are partly reused among different network slices, SCCVₛ can be fraction of CCCV such that Σₛ₌₁^{N}^{_{slices}}SCCVₛ≥CCCV. For instance, network slices may be configured to have a minimum guaranteed number of resources such that Σₛ₌₁^{N}^{_{slices}}SCCV_{s,min}=CCCV but could be allowed to pull resources from other network slices if their traffic is low, up to a maximum amount of resources. In this case, the value SCCVₛ may be expressed associated to a network slice s to range in an interval [SCCV_{s,min},SCCV_{s,max}].

In some embodiments, the available capacity associated to the radio cell is determined based on the available capacity associated to one or more network slices. In one embodiment, the available capacity associated to the radio cell is computed as

$${CAC}_{cell} = \frac{CCCV}{{\sum }_{s = 1}^{{N}_{slices}} {SCCV}_{s}} {\sum }_{s = 1}^{{N}_{slices}} {CAC}_{s}$$

The sum of the available capacity CACₛ associated to the multiple network slices is scaled in proportion to the cell capacity class value normalized by the sum of the slice capacity class values. The normalization is useful in the case where the cell resources are reused, fully or only in part, between network slices.

In some embodiments, the available capacity associated to the radio cell is computed as

$${CAC}_{cell} = \frac{1}{{N}_{slices}} {\sum }_{s = 1}^{{N}_{slices}} {CAC}_{s}$$

The cell available capacity is represented by the average available capacity associated to all network slices.

Particular embodiments include available capacity associated to network slices and downlink reference signal beams. A partition of the radio cell is represented by the resource utilization associated to a network slice within the coverage area of a reference signal beam. The available capacity associated to a network slice s within the coverage area of a reference signal beam b can be determined as

CAC_{s,b}=SCCV_{s,b}·SCV_{s,b} S=1, . . . N_{slices} b=1, . . . , N_{beams}

where SCCV_{s,b} indicates the total resources configured for a slices within the coverage area of a beam b for traffic purposes, whereas SCV_{s,b} indicates the amount of resources that are available for the network slice within the coverage area of a reference signal beam relative to the total resources SCCV_{s,b}.

The value of SCCVₛ can be determined as a function of the cell capacity class value (CCCV) depending on how the cell resources are distributed among different network slices and the coverage area of downlink reference signal beams. In one example, SCCV_{s,b}=CCCV for all network slices under the coverage area of all reference signal beams, i.e. the cell resources are fully reusable among all network slices and among the coverage area of all reference signal beams.

In another example, each network slice is associated a Slice Capacity Class Value SCCVₛ representing a fraction of the cell CCCV such that Σₛ₌₁^{N}^{_{slices}} SCCVₛ=CCCV (i.e., the cell's resources are orthogonally divided among network slices) and SCCV_{s,b}=SCCVₛ for all coverage areas of reference signal beams. In other words, the resources dedicated to a network slice are fully reusable among the coverage area of different reference signal beams.

In another example, each network slice is associated a Slice Capacity Class Value SCCVₛ representing a fraction of the cell CCCV and SCCV_{s,b}=SCCVₛ for all coverage areas of reference signal beams. In other words, each network slice is allocated a fraction of the cell's network resources that may partly overlap with the resources allocated to another network slice, and the resources dedicated to a network slice are fully reusable among the coverage area of different reference signal beams.

In some embodiments, the available capacity associated to the radio cell is determined based on the available capacity associated to one or more network slices within the coverage area of one or more reference signal beams. In one embodiment, the available capacity associated to the radio cell is computed as

$${CAC}_{cell} = \frac{CCCV}{{\sum }_{s = 1}^{{N}_{slices}} {\sum }_{b = 1}^{{N}_{beams}} {SCCV}_{s , b}} {\sum }_{s = 1}^{{N}_{slices}} {\sum }_{b = 1}^{{N}_{beams}} {CAC}_{s , b}$$

In other embodiments, when a network slice can fully reuse the value SCCVₛ among the coverage area of multiple reference signal beams, the available capacity associated to the radio cell is computed as

$${CAC}_{cell} = \frac{CCCV}{{\sum }_{s = 1}^{{N}_{slices}} {SCCV}_{s}} {\sum }_{s = 1}^{{N}_{slices}} {\sum }_{b = 1}^{{N}_{beams}} {CAC}_{s , b}$$

The cell available capacity is represented by the average available capacity associated to all network slices.

$${CAC}_{cell} = \frac{1}{{N}_{slices} {N}_{beams}} {\sum }_{s = 1}^{{N}_{slices}} {\sum }_{b = 1}^{{N}_{beams}} {CAC}_{s , b}$$

In some embodiments, a partition of the radio cell is represented by a bandwidth part of an uplink or a downlink carrier band. Therefore, the radio network node computes the available capacity associated to one or more bandwidth part of a downlink or uplink carrier.

The network node can further compute the available capacity associate to the radio cell based on the available capacity associated with at least one bandwidth part.

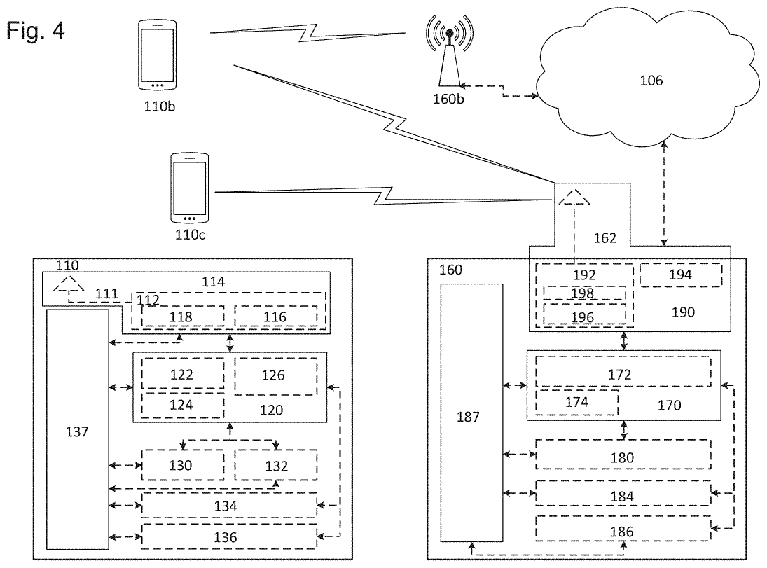

FIG. 4 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), New Radio (NR), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes. SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 160 includes processing circuitry 170, device readable medium 180, interface 190, auxiliary equipment 184, power source 186, power circuitry 187, and antenna 162. Although network node 160 illustrated in the example wireless network of FIG. 4 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174, In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, hoards, or units

In certain embodiments, some or all of the functionality described herein as being provided by a network node, base station, eNB, gNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160, Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more on sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 4 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WI) 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 1H may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RE transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RE transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RE transceiver circuitry 122, baseband processing circuitry 124, and application processing circuitry 126 may be combined in the same chip or set of chips. In some embodiments, RE transceiver circuitry 122 may be a part of interface 114. RE transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by, a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction max be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry, User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry, Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

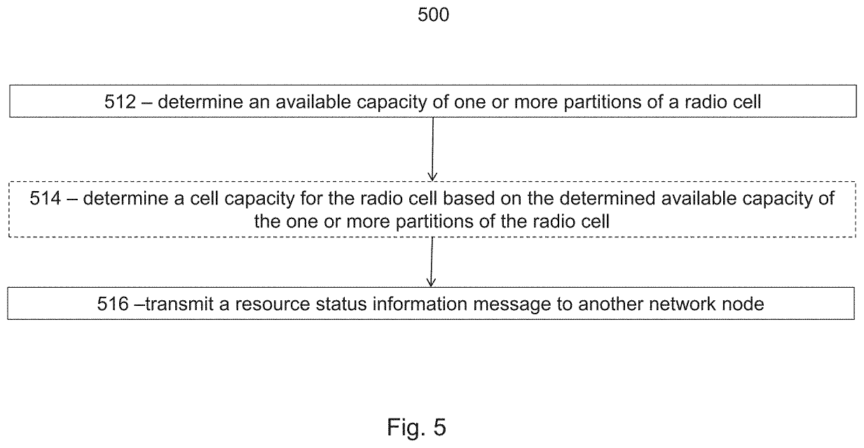

FIG. 5 is a flowchart illustrating an example method in a network node, according to certain embodiments. In particular embodiments, one or more steps of FIG. 5 may be performed by network node 160 described with respect to FIG. 4. The network node is operable to determine available capacity.

The method begins at step 512, where the network node (e.g., network node 160) determines an available capacity of one or more partitions of a radio cell. For example, the partitions may comprise coverage areas of one or more reference signal beams, such as one or more synchronization signal blocks (SSBs) beams. In some embodiments, the one or more partitions of the radio cell may comprise one or more network slices, or the one or more partitions of the radio cell may comprise one or more network slices and coverage areas of one or more reference signal beams.

In particular embodiments, determining the available capacity of one or more partitions of the radio cell is based on all cell resources being available to each of the one or more partitions of the radio cell.

For example, the available capacity of a partition of the radio cell may be a composite available capacity comprising a partition capacity class value and a partition capacity value wherein the partition capacity class value is equal to a cell capacity class value, and the partition capacity value is an amount of resources available within the partition relative to the partition capacity class value.

In particular embodiments, determining the available capacity of one or more partitions of the radio cell is based on a fraction of cell resources being available to each of the one or more partitions of the radio cell.

For example, the available capacity of a partition of the radio cell may be a composite available capacity comprising a partition capacity class value and a partition capacity value wherein the partition capacity class value is smaller than a cell capacity class value and the sum of the partition capacity class value of all partitions equals the cell capacity class value, and the partition capacity value is the amount of resources available within the partition relative to the partition capacity class value.

As another example, the available capacity of a partition of the radio cell may be a composite available capacity comprising a partition capacity class value and a partition capacity value wherein the partition capacity class value is smaller than a cell capacity class value and the sum of the partition capacity class value of all partitions exceeds the cell capacity class value, and the partition capacity value is the amount of resources available within the partition relative to the partition capacity class value.

In some embodiments, the available capacity of a partition of the radio cell is determined according to any of the embodiments and examples described herein.

At step 514, the network node may determine an available cell capacity for the radio cell based on the determined available capacity of the one or more partitions of the radio cell. For example, the network node may average each of the available capacities of the one or more partitions of the radio cell. In some embodiments, the network node determines the available cell capacity according to any of the embodiments and examples described herein.

At step 516, the network node transmits a resource status information message to another network node. The resource status information message comprises at least one of the determined available capacities of the one or more partitions of the radio cell, and may also include the determined available cell capacity.

Modifications, additions, or omissions may be made to method 500 of FIG. 5, Additionally, one or more steps in the method of FIG. 5 may be performed in parallel or in any suitable order.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a network node for determining available capacity, the method comprising:
determining an available capacity of one or more partitions of a radio cell; and
transmitting a resource status information message to another network node, the resource status information message comprising at least one of the determined available capacities of the one or more partitions of the radio cell.

2. The method of claim 1, further comprising:
determining an available cell capacity for the radio cell based on the determined available capacity of the one or more partitions of the radio cell; and
wherein the resource status information includes the available cell capacity for the radio cell.

3. The method of claim 1, wherein determining the available capacity of one or more partitions of the radio cell is based on all cell resources being available to each of the one or more partitions of the radio cell.

4. The method of claim 1, wherein the available capacity of a partition of the radio cell is a composite available capacity comprising a partition capacity class value and a partition capacity value wherein the partition capacity class value is equal to a cell capacity class value, and the partition capacity value is an amount of resources available within the partition relative to the partition capacity class value.

5. The method of claim 1, wherein determining the available capacity of one or more partitions of the radio cell is based on a fraction of cell resources being available to each of the one or more partitions of the radio cell.

6. The method of claim 1, wherein the available capacity of a partition of the radio cell is a composite available capacity comprising a partition capacity class value and a partition capacity value wherein the partition capacity class value is smaller than a cell capacity class value and a sum of partition capacity class value of all partitions equals the cell capacity class value, and the partition capacity value is an amount of resources available within the partition relative to the partition capacity class value.

7. The method of claim 1, wherein the available capacity of a partition of the radio cell is a composite available capacity comprising a partition capacity class value and a partition capacity value wherein the partition capacity class value is smaller than a cell capacity class value and a sum of partition capacity class value of all partitions exceeds the cell capacity class value, and the partition capacity value is an amount of resources available within the partition relative to the partition capacity class value.

8. The method of claim 2, wherein determining the available cell capacity for the radio cell comprises averaging each of the available capacities of the one or more partitions of the radio cell.

9.-10. (canceled)

11. The method of claim 1, wherein the one or more partitions of the radio cell comprise one or more network slices.

12. (canceled)

13. A network node operable to determine available capacity, the network node comprising processing circuitry operable to:
determine an available capacity of one or more partitions of a radio cell; and
transmit a resource status information message to another network node, the resource status information message comprising at least one of the determined available capacities of the one or more partitions of the radio cell.

14. The network node of claim 13, the processing circuitry further operable to:
determine an available cell capacity for the radio cell based on the determined available capacity of the one or more partitions of the radio cell; and
wherein the resource status information includes the available cell capacity for the radio cell.

15. The network node of claim 13, wherein the processing circuitry is operable to determine the available capacity of one or more partitions of the radio cell based on all cell resources being available to each of the one or more partitions of the radio cell.

16. The network node of claim 13, wherein the available capacity of a partition of the radio cell is a composite available capacity comprising a partition capacity class value and a partition capacity value wherein the partition capacity class value is equal to a cell capacity class value, and the partition capacity value is an amount of resources available within the partition relative to the partition capacity class value.

17. The network node of claim 13, wherein the processing circuitry is operable to determine the available capacity of one or more partitions of the radio cell based on a fraction of cell resources being available to each of the one or more partitions of the radio cell.

18. The network node of claim 13, wherein the available capacity of a partition of the radio cell is a composite available capacity comprising a partition capacity class value and a partition capacity value wherein the partition capacity class value is smaller than a cell capacity class value and a sum of partition capacity class value of all partitions equals the cell capacity class value, and the partition capacity value is an amount of resources available within the partition relative to the partition capacity class value.

19. The network node of claim 13, wherein the available capacity of a partition of the radio cell is a composite available capacity comprising a partition capacity class value and a partition capacity value wherein the partition capacity class value is smaller than a cell capacity class value and a sum of partition capacity class value of all partitions exceeds the cell capacity class value, and the partition capacity value is an amount of resources available within the partition relative to the partition capacity class value.

20. The network node of claim 14, wherein determining the available cell capacity for the radio cell comprises averaging each of the available capacities of the one or more partitions of the radio cell.

21.-22. (canceled)

23. The network node of claim 13, wherein the one or more partitions of the radio cell comprise one or more network slices.

24.-38. (canceled)

39. A non-transitory machine-readable medium having stored thereon instructions that when executed by at least one machine, cause the machine to perform operations comprising:
determining an available capacity of one or more partitions of a radio cell; and
transmitting a resource status information message to another network node, the resource status information message comprising at least one of the determined available capacities of the one or more partitions of the radio cell.

40. The non-transitory machine-readable medium of claim 39, the operations further comprising:
determining an available cell capacity for the radio cell based on the determined available capacity of the one or more partitions of the radio cell;
wherein the resource status information includes the available cell capacity for the radio cell; and
wherein the one or more partitions of the radio cell comprise one or more network slices.
